(19) United States
(12) Patent Application Publication
(10) Pub. No.: US 2005/0242941 A1
(43) Pub. Date: Nov. 3, 2005

(54) Third brake light of small-sized truck

(76) Inventor: Lance Chao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/834,212

(22) Filed: Apr. 29, 2004

(51) Int. Cl. B60Q 1/44

(52) U.S. Cl. 340/479

(57) ABSTRACT

A third brake light is attached to a rear deck door panel of a truck so as not to interfere with opening/closing of the door panel. The third brake light includes a base attached to the door panel of the truck and forming an exposed surface to which a plurality of illuminators, such as light-emitting diodes, light bulbs and cold light panels, is mounted. An electrical cable electrically connects the illuminators to an electricity system of the truck. A light-transmitting cover having a size and shape corresponding to the base is attached to the exposed surface of the base for shielding and protection of the illuminators.

### BACKGROUND OF THE INVENTION

1. Field of the Invention

The present invention generally relates to a third brake light of automobiles, and in particular to a third brake light for a small-sized truck, such as a pickup truck.

2. The Related Art

For driving safety, automobile drivers must watch the cars in front of him or her in order to take proper actions. One of the most important signs that the automobile drivers can get from the front cars is the brake light of the front car. Conventionally, two brake lights are respectively mounted on opposite sides of the tail portion of a car, which sometimes may cause the eyesight of the drivers of the following cars to shift from the straightforward direction in which the car is moving, leading to unexpected accidents.

A third brake light overcomes such a problem by being positioned at a center of the tail portion of a car. The third brake light is located at a raised position as compared to the conventional brake lights that are arranged next to the taillights of the car. However, the third brake light that is currently available is designed for passenger cars and is attached to a high position of the rear windshield of the car. This is not applicable to a truck, such as a pickup truck, for the truck does not have a rear windshield located close to the tail portion.

Thus, the present invention is aimed to provide a third brake light which meets the particular configuration of small-sized trucks so as to overcome the drawbacks of the conventional third brake light.

### SUMMARY OF THE INVENTION

Thus, a primary objective of the present invention is to provide an automobile third brake light that is mounted to a rear door panel of cargo deck of a small-sized truck to give off warnings to the following cars in a traffic line so as to reduce potential risk of traffic accidents.

To achieve the above objectives, in accordance with the present invention, there is provided a third brake light mountable to a rear door panel of a rear deck of a truck, such as a pickup truck, so as not to interfere with opening/closing of the door panel. The third brake light comprises a base attached to the door panel of the truck and forming an exposed surface to which a plurality of illuminators, such as light-emitting diodes, light bulbs and cold light panels, is mounted. An electrical cable electrically connects the illuminators to an electricity system of the truck. A light-transmitting cover having a size and shape corresponding to the base is attached to the exposed surface of the base for shielding and protection of the illuminators.

### BRIEF DESCRIPTION OF THE DRAWINGS

The present invention will be apparent to those skilled in the art by reading the following description of preferred embodiments thereof, with reference to the attached drawings, in which:

FIG. 1 is a rear side view of a small-sized truck to which a third brake light constructed in accordance with the present invention is attached;

FIG. 2 is an enlarged view of a rear door panel of the small-sized truck to which the third brake light of the present invention is attached;

FIG. 3 is an exploded view of the third brake light of the present invention;

FIG. 4 is an assembled view of FIG. 3;

FIG. 5 is an exploded view of a third brake light constructed in accordance with another embodiment of the present invention; and

FIG. 6 is an exploded view of a third brake light constructed in accordance with a further embodiment of the present invention.

### DETAILED DESCRIPTION OF THE PREFERRED EMBODIMENTS

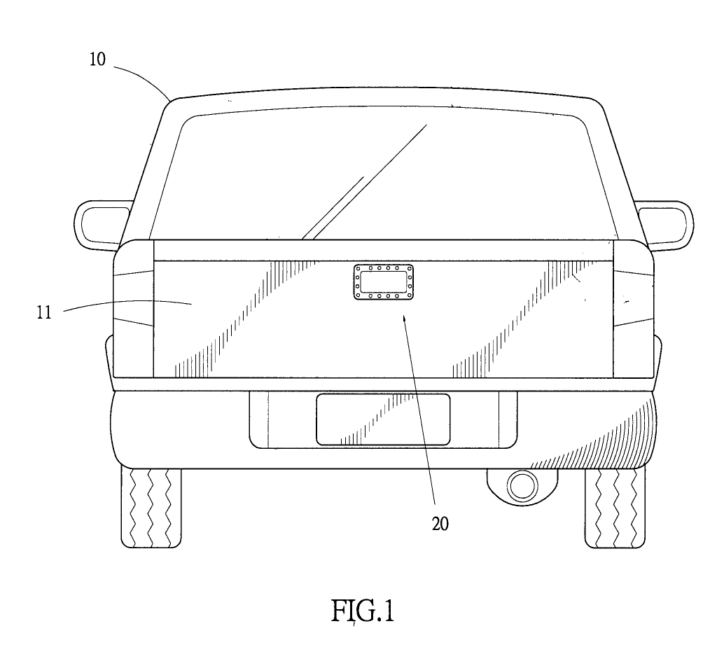

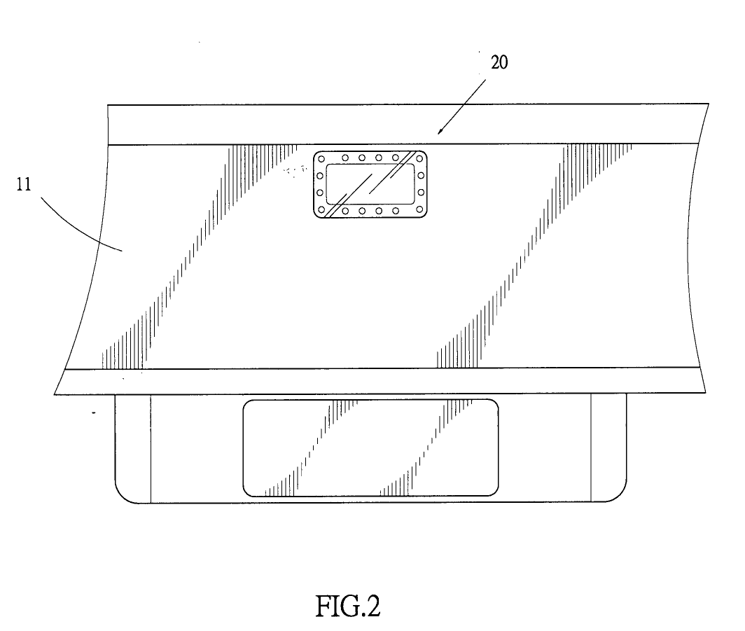

With reference to the drawings and in particular to FIGS. 1 and 2, a third brake light for automobile constructed in accordance with the present invention, generally designated with reference numeral 20, is attached to an upper edge of a rear door panel of a deck of a small-sized truck 10, such as a pickup truck, to enhance warning of the following car when driver of the truck 10 take actions to decelerate the truck 10.

In general, the small-sized truck 10 in which the present invention is embodied is specifically a truck having a rear side deck for cargo loading. The deck is defined by two lateral sidewalls and a rear door panel 11 that can be rotated about a rear edge of the deck to open the rear end of the truck 10 for loading/unloading cargos. Latch or locking means (not shown) may be provided on an inside surface of the door panel 11 to selectively and releasably secure the door panel 11 in an upright position for preventing the cargos from sliding off the deck during transportation. This is known and no further detail is needed.

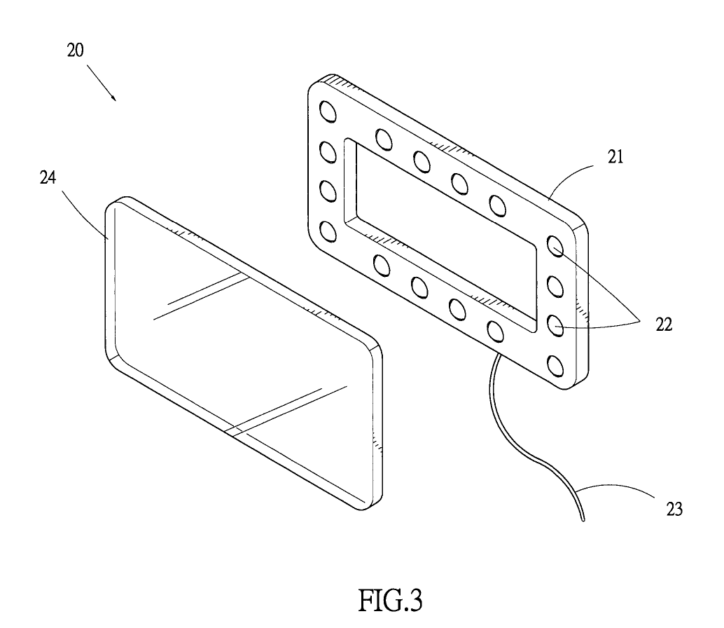

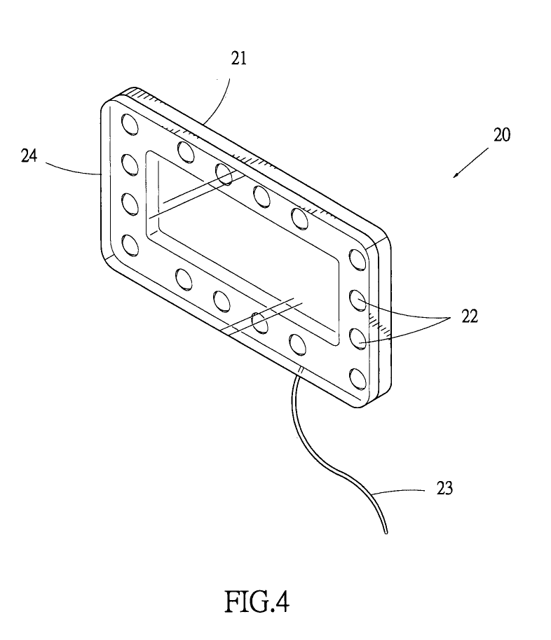

Also referring to FIGS. 3 and 4, the third brake light 20 of the present invention comprises a base 21, generally a flat member, which is shaped as a rectangular frame in the embodiment illustrated having an outside surface and an opposite inside surface. A plurality of illuminators or light sources 22 are mounted on the outward surface, preferably distributed in an equally-spaced manner along each side of the frame. A cable 23 is attached to the base 21 and in electrical connection with each illuminator 22 to selectively power the illuminator 22. The cable 23 is connected to and controlled by a brake light control circuit of the truck 10 whereby when the truck driver hits the deceleration pedal, the brake light control circuit supplies power to the illuminators 22 and causing them to give off light.

A cover 24, made of light transmitting material, such as transparent, and having a shape and size corresponding to the base 21 is attached to the outward surface of the base 21 to cover and shield the illuminators 22 for protection and other purposes.

In the embodiment illustrated in FIGS. 1-4, the third brake light 20 is made in the form of a rectangular frame having four sides with the illuminators 22 distributed along each side. It is apparent to those having ordinary skills to shape the third brake light 20 in different forms, such as ring, ellipse and multilateral configuration.

An example of the illuminators 22 is light-emitting diode. Alternatively, the illuminators 22 may comprise light bulbs.

The brake light 20 is mounted to the deck door panel 11 by having the inward surface thereof positioned on and attached to the door panel 11 by means of for example adhesives and bolts.

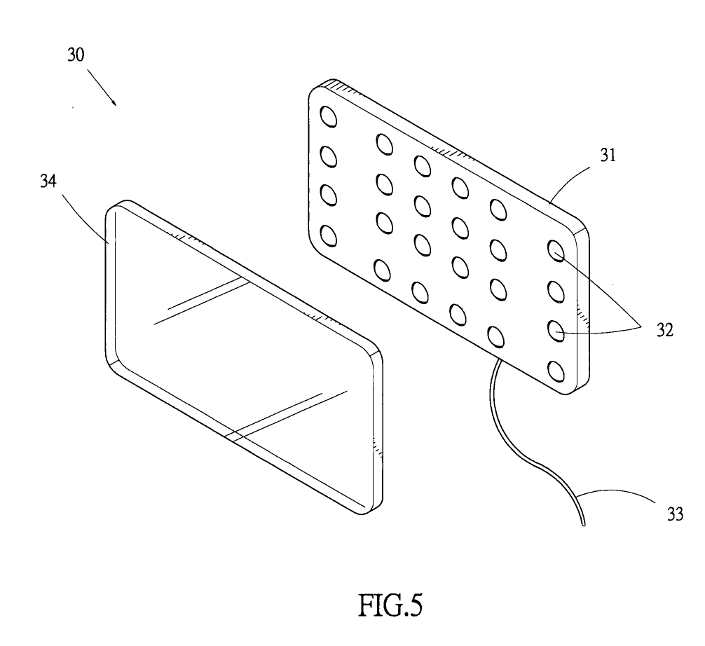

Referring to FIG. 5, which shows a different embodiment of the third brake light of the present invention, generally designated with reference numeral 30 for distinction, the brake light 30 comprises a base 31 in the form of a flat thin plate having an inward surface to be attached to the door panel 11 of the truck by means of for example adhesives and bolts and an outward surface on which a plurality of illuminators 32, such as light-emitting diodes, is arranged in an array. A cable 33 electrically connects the illuminators 32 to the brake light control circuit of the truck. A cover 34, made of light-transmitting material and having the same shape and size as the base 31, is attached to the outward surface of the base 31 for protection and shielding of the illuminators 32.

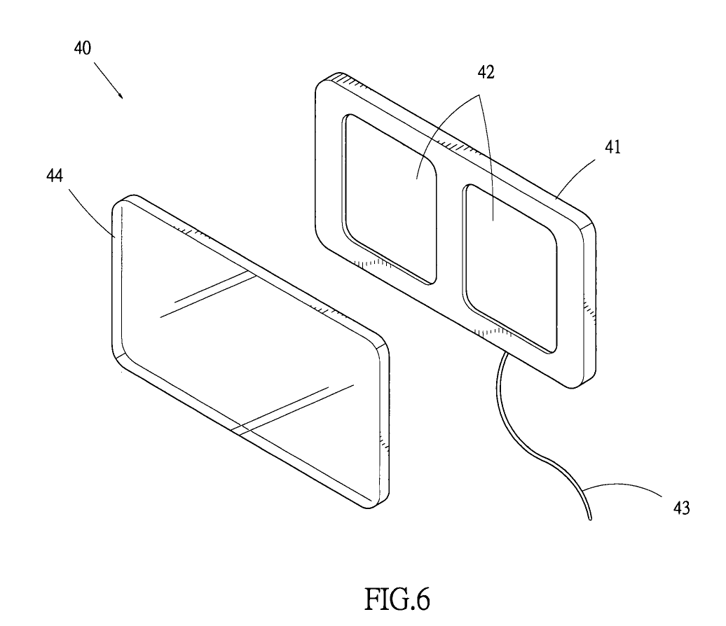

Referring to FIG. 6, which shows a further embodiment of the third brake light of the present invention, generally designated with reference numeral 40 for distinction, the brake light 40 comprises a base 41 in the form of a flat thin plate having an inward surface to be attached to the door panel 11 of the truck by means of for example adhesives and bolts and an outward surface on which two planar light sources 42, such as bulb-based planar light source and cold light panel, are mounted and appropriately spaced from each other. A cable 43 electrically connects the light sources 42 to the brake light control circuit of the truck. A cover 44, made of light-transmitting material and having the same shape and size as the base 41, is attached to the outward surface of the base 41 for protection and shielding of the light sources 32.

Although the present invention has been described with reference to the preferred embodiments thereof, it is apparent to those skilled in the art that a variety of modifications and changes may be made without departing from the scope of the present invention which is intended to be defined by the appended claims.

1. A brake light adapted to be attached to a rear deck door panel of a truck, comprising:
a base adapted to attach to the door panel and having an exposed surface;
illuminators mounted to the exposed surface of the base;
an electrical cable connecting the illuminators to an electricity system of the truck;
a light-transmitting cover having a size and shape corresponding to the base and attached to the exposed surface of the base for shielding the illuminators.

2. The brake light as claimed in claim 1, wherein the base is selectively assumed different shapes.

3. The brake light as claimed in claim 1, wherein the base is attached to the door panel by adhesives.

4. The brake light as claimed in claim 1, wherein the base is attached to the door panel by fasteners.

5. The brake light as claimed in claim 1, wherein the illuminators comprise light-emitting diodes.

6. The brake light as claimed in claim 1, wherein the illuminators comprise cold light panels.

7. The brake light as claimed in claim 1, wherein the illuminators comprise electrical bulbs.
